(19) United States
(12) Patent Application Publication
(10) Pub. No.: US 2012/0109829 A1
(43) Pub. Date: May 3, 2012

(54) METHOD AND SYSTEM FOR PROCESSING TRANSACTIONS USING A TOKEN

(75) Inventors: Joan Tibor McNeal, Waycross, GA (US); Kellie Rogers, Macclenny, FL (US)

(73) Assignee: EXODUS PAYMENT SYSTEMS, LLC, Blackshear, GA (US)

(21) Appl. No.: 13/284,728

(22) Filed: Oct. 28, 2011

Related U.S. Application Data
(60) Provisional application No. 61/408,525, filed on Oct. 29, 2010.

(51) Int. Cl. G06Q 20/40

(52) U.S. Cl. 705/67

(57) ABSTRACT

Methods and systems of preventing fraud in electronic transaction and verification are described herein. The method includes obtaining information from a recipient; splitting the information into multiple parts; encrypting one or more of the multiple parts and encoding said encrypted part on different locations of a token; and encrypting the remaining portions of the split information and storing the encrypted remaining portions in one or more information stores. At a subsequent time, when the recipient provides the token to complete a transaction or to establish identity, retrieving the multiple portions from the one or more information stores and the token and combining or re-mating the multiple portions retrieved from the token and the one or more information stores.

### CROSS-REFERENCE TO RELATED APPLICATIONS

This application claims priority to U.S. Provisional Patent Application No. 61/408,525, filed on Oct. 29, 2010, entitled “METHOD AND SYSTEM FOR ENCODING PERSONAL INFORMATION ON AN ELECTRONIC TOKEN.” The disclosure of the prior application is considered part of, and is incorporated by reference in, this disclosure.

### BACKGROUND

1. Field of the Invention

This disclosure generally relates to credit, insurance and identity verification systems. More particularly, this disclosure relates to approval and fraud protection at the point-of-transaction for a transaction or a service wherein personal information is used to verify the identity of a person presenting a token as an authorized user.

2. Description of the Related Art

A token can be used to store or reference information associated with an individual. The personal information can include but not be limited to information related to various financial accounts of an individual; various credit cards issued to one or more individuals; medical history of one or more individuals; insurance or other medical benefits information for one or more individuals; information related to medications prescribed to an individual; home loan accounts and mortgage accounts associated with an individual, passwords, security codes, etc. However, in the event of a loss or theft of the token, all the personal information stored in the token can be compromised. Thus, methods and systems that can adequately protect the personal information stored on the token are useful.

### SUMMARY

The systems, methods and devices of the disclosure each have several innovative aspects, no single one of which is solely responsible for the desirable attributes disclosed herein.

Various implementations disclosed herein describe a method of storing information on a token which includes obtaining personal information from a user; dividing the personal information into multiple portions; storing one or more sub-portions of the multiple portions on a token associated with the user; and storing the remaining or at least some other sub-portions of the multiple portions that are different from one or more sub-portions stored on the token in one or more information stores. In various implementations, the multiple sub-portions may be further divided into multiple sub-parts. In various implementations, a user can present the token for the purpose of a financial transaction. In various implementations, a user can present the token for the purpose of verifying or establishing identity or for security clearance.

In various implementations, the personal information obtained from the user can include biometric information, for example, finger print, retinal scan, palm print, face scan, footprint, vein scan, heart scan, voice signature, personal signature, etc. In various implementations, the personal information obtained from the user can include responses to one or more security questions. In various implementations, the personal information obtained from the user can include at least one of: a date of birth, a name, a place of birth, information regarding a financial or a medical account, a personal identification number, for example, social security number, government issued benefit accounts, government issued identification numbers, etc.

In various implementations, the token can include a negotiable instrument, a credit card, a debit card, a loyalty card, a decoupled debit card, a device enabled with radio frequency identification, a smart card, a flash drive, a usb thumb drive, a usb pen drive, a usb pin drive, a smart phone (e.g. an IPHONE®), a tablet computer (e.g. an IPAD®), an application developed for an electronic device, an electronic benefit card, an insurance card or a food stamp. In various implementations, the token can include a card with one or more electronic circuits or chips that can store or reference information in electronic form.

In various implementations, the one or more sub-portions stored or referenced on the token can be further divided into multiple parts and a first sub-part of the multiple parts can be stored or referenced at a first location on the token and a second sub-part can be stored or referenced at a second location on the token. The first and the second location may be different physical locations on the token or different logical locations (e.g. different electronic databases or files) on the token.

In various implementations, the remaining sub-portions different from the one or more sub-portions stored or referenced on the token can be subdivided into multiple parts and each of the multiple parts can be stored or referenced in one or more information stores. In various implementations, the multiple parts can be stored or referenced at different logical locations (e.g. different databases or electronic files) within the same information store or in information stores at different physical locations.

In various implementations, the multiple portions, sub-portions, parts and sub-parts of the personal information can be scrambled and/or encrypted prior to being stored or referenced on the token or in the one or more information store. In various implementations, the personal information can be scrambled and/or encrypted prior to being split/divided and stored or referenced.

Various implementations disclosed here describe a method of processing a transaction at a location where a token is presented by an individual. The method includes obtaining personal information from an individual presenting a token; obtaining information from the token; accessing one or more information stores using at least one of a portion of the personal information obtained from the individual and/or the information obtained from the token (e.g. token number); retrieving information from the one or more information stores; combining the information obtained from the token with the information retrieved from the one or more information stores; and using the combined information along with the personal information from the individual to process the transaction.

Various implementations disclosed herein describe a transaction verification system comprising: a device configured to obtain information stored or referenced in a token; a device configured to obtain personal information from a customer/individual associated with the token; and a communication system configured to communicate with a transaction system. In various implementations, the transaction system may be configured to compare the personal information obtained from the customer with the information obtained from/associated with the token and/or information stored or referenced in the external system. In various implementations, the transaction system may be configured to retrieve information associated with the token that is stored or referenced in one or more information stores and combine the retrieved information with the information obtained from the token to process the transaction.

In various implementations, processing the transaction can include authorizing transfer of goods, services and money between the customer presenting the token and the entity accepting the token. In various implementations, processing the transaction can include verifying the identity of an individual for the purpose of access control or to record the time and date of attendance.

A method of enrolling a customer or an individual is described herein. The method comprises obtaining biometric information from the customer and/or answers to a plurality (e.g. five) of security questions and associating the biometric information and/or answers to security questions with the identity information of the customer.

Methods and systems of preventing fraud in electronic transaction and verification are described herein. The method includes obtaining information from a recipient; splitting and/or dividing the information into multiple parts; storing or referencing one or more of the multiple parts on different locations of a token; storing or referencing the remaining or at least some other portions of the split/divided information in one or more external information stores. At a subsequent time, when the recipient provides the token to complete a transaction, information stored in one or more external information stores is retrieved and combined with the information stored on the token. In various implementations, the information obtained from the recipient can be scrambled and/or encrypted prior to being split or divided. In various implementations, the information obtained from the recipient can be scrambled and/or encrypted after being split or divided and the scrambled and/or encrypted portions of information being stored or referenced. In various implementations, the information stored or referenced in one or more information stores can be retrieved by using a portion of the personal information (e.g. a biometric information, a personal identifier or a token identifier). In various implementations, the personal information obtained from the recipient can be compared with the personal information retrieved from the token or one or more external databases before retrieving information from the one or more external information stores.

Various implementations include a smart card that provides easy, fraud-resistant payment options and securely stores or references information (e.g. financial information, insurance information, prescriptions and medical history). The stored or referenced information may be retrieved easily in case of an emergency or during a visit to the service provider's office.

In various implementations, the smart card can be an alternative to traditional debit/credit cards. Information (e.g. financial data) associated with a user is split and scrambled before being stored or referenced on the smart card. Information stored or referenced on the card can be secured by a personal identification number (PIN) that is associated with the user's biometric information. The biometric PIN ensures that only the user can access the information stored or referenced on the smart card or use the smart card to make a transaction

In various implementations, if the personal information obtained from the recipient includes biometric information, the biometric information can be divided into multiple parts and stored or referenced at different locations. In various implementations, the multiple parts of the divided biometric information can be stored or referenced either as multiple image parts or as a set of alpha-numeric characters. In various implementations, the multiple parts of the biometric information can be stored or referenced partly on a token (e.g. the smart card) and partly in one or more information stores.

### BRIEF DESCRIPTION OF THE DRAWINGS

FIG. 1 illustrates an example embodiment of a smart card.

FIG. 2 illustrates a method of storing information.

FIG. 3 illustrates a method of processing a transaction.

FIG. 4 illustrates an example transaction processing system.

Like reference numbers and designations in the various drawings indicate like elements.

### DETAILED DESCRIPTION OF THE PREFERRED EMBODIMENT

It would be advantageous to prevent and/or reduce fraud in electronic transaction and verification systems (e.g. Medicaid/Medicare systems; food stamps; credit/debit card transactions; bank transactions, etc,). The implementations disclosed in the present application are directed towards preventing or reducing various types of fraud in electronic transaction and verification systems. Some examples of the frauds that can be prevented or reduced by the implementations disclosed in this application are: (i) misuse of identities of recipients; (ii) misuse of identities of providers; and (iii) phantom billing by providers. Without any loss of generality the various types of frauds are further explained below with reference to preventing fraud in Medicare/Medicaid and EBT systems.

One type of fraud in Medicaid systems is recipient fraud which is explained in further detail below. Most people who receive Medicaid benefits follow the legal guidelines. However, a percentage of individuals can abuse the privileges and attempt to deceive the state and/or the federal government. Recipient fraud can include prescription drug forgery, theft of Medicaid recipient benefit information, Medicaid card sharing, drug diversion, etc. For example, parents can use another child's name to obtain care for their sick child who is not enrolled in the system or not entitled for the benefit. Beyond being fraudulent, this can also be medically dangerous for society. For example, if a parent chooses to substitute a child for care, and the child ends up missing an inoculation, or is given a drug to which they are allergic because a false name is used, the results could be life threatening. Additionally, a child can be overdosed, or given extra vaccines which they do not require. This can result in children being unprotected from disease in school settings, or overly medicated, both which can be disastrous. Other harmful/consequences of medical fraud other than described above are possible.

One method of preventing fraud during a transaction is to verify the identity of the recipient prior to completing the transaction. In various implementations, completing the transaction can include providing goods or services in exchange for money. In the case of Medicaid, most recipient fraud could be eliminated by requiring, for example, a smart card and biometric/fingerprint system for the dispensing of any service. In this manner, no service can be obtained by a third party abusing another's card, no prescription can be filled, no member additions or substitutions can be made, and no drug diversions can occur.

On the recipient's part, the ability to defraud and the economic incentive to defraud can be reduced by adopting this method. Moreover, any recipient trying to defraud the system can be placed in a negative database and be prohibited from receiving further benefits.

Another type of fraud in Medicaid systems can be provider fraud which is described in further detail below. Medicaid providers can include doctors, dentists, hospitals, nursing homes, pharmacies, clinics, counselors, personal care/homemaker chore companies, equipment and supplies, and many other medical service companies being paid by the Medicaid program. Honest providers can become victims of identity theft. For example, their provider numbers can be stolen and used by criminals to defraud the system. This not only causes increased cost on the Medicaid system, but often puts honest providers under a certain level of investigation until it is realized their identity has been stolen.

Provider fraud can occur if a provider intentionally misrepresents the services rendered, and increases their reimbursement from Medicaid. Recent data from the U.S. government reveals that provider fraud is on the rise.

Like recipient fraud, providers have a variety of ways they can deceive the state. For example, they can bill for medical services not actually performed (phantom billing), bill for more expensive services than those actually rendered (up-coding), bill for several services that should be combined in one billing (unbundling), bill twice for the same service, dispense generic drugs but bill for brand-name drugs, give or accept something in return for medical services (kickbacks), outright bribery, providing unnecessary services, create false cost reports, embezzle recipient funds and more.

Eliminating most potential for fraud can be accomplished by using the methods and systems described herein. Honest providers can protect themselves with the systems and methods described herein, and providers who knowingly double bill or use any of the other tactics mentioned can be tracked by the systems and methods described herein. Most overbilling is done by providers after hours. In various implementations of the systems and methods described herein it is envisioned that billing for the service occurs at the time the services are rendered, thereby eliminating or reducing the aforementioned fraudulent practices.

With time stamps for arrival and departure, more expensive, lengthy and cumbersome tests claimed to have been performed can be confirmed or denied. Each facet of provider fraud currently abusing the system can be tracked and providers committing fraud can lose their medical license. The economic gain from cheating the system would not offset the loss of the ability to practice medicine, therefore, a large portion of Medicaid fraud could disappear due to the disincentives.

### Benefits of Preventing/Reducing Medicaid Fraud

Systems and methods that can prevent or reduce Medicaid fraud can be advantageous. For example, currently those who need exceptional medical care are being denied or delayed treatment because of the extra burden placed on the public Medicaid system by fraudulent recipients. When doctors or hospitals schedule a test, scan or other high level procedure on someone who is abusing the system that usually means someone else has been delayed or denied access. Reducing fraud can decrease wait times for critical services, and can ultimately reduce the costs of tests. Medicaid patients and general consumers can both benefit while regular taxpaying consumers need no longer be subsidizing fraudulent charges.

Providers also suffer as a group when those within the medical profession commit fraud. For example, insurance costs and malpractice rates are higher. Office overhead and procedures are more costly. Eliminating or preventing fraud can restore the honor of the medical profession.

Recently there have been numerous reports on breach of security of data servers managed by large corporations or federal and state governments. Some of these data servers are used to store sensitive personal and financial information associated with individuals and individuals are rightly concerned that their sensitive personal and financial information could be compromised. Thus, systems and methods that can protect sensitive personal and financial information (e.g. biometric information, social security numbers, bank account numbers, etc.) even in the event of a security breach of data server that are used to store information of such type are desirable. Various implementations disclosed herein include dividing/splitting sensitive personal information associated with an individual into multiple portions and storing or referencing each of the multiple portions either on a token associated with the individual or in one or more databases. In various implementations, the information is divided such that each individual portion cannot be used to reconstruct the entire information. In various implementations, the information can be unlocked only when the individual authorizes access, for example, by providing his or her biometric information. This method of storing or referencing information ensures that sensitive personal information is not compromised even if the security of the one or more databases used to store the multiple portions is breached.

### Example Embodiments of Methods and Systems to Prevent Fraud

The methods and systems described herein can address most forms of fraud, e.g. Medicaid fraud, government fraud, bank fraud, credit card fraud, etc. For example, the methods and systems described herein can eliminate or prevent provider fraud in Medicaid systems by: (a) preventing methods to defraud the system by stealing identity of the recipients/providers; (b) eliminating/reducing phantom billing; (c) reducing home health care and physical therapy fraud; (d) eliminating/reducing transportation billing fraud; (e) eliminating/preventing phantom billing DMEPOS (Durable medical equipment, prosthesis, orthotics and supplies) fraud; (f) mitigating up-coding charges; (g) eliminating/preventing billing for service prior to treatment; (h) eliminating/reducing billing a recipient for covered service; (i) eliminate/reducing billing Medicaid for non-covered service; (j) mitigating split billing.

As another example, the methods and systems described herein can eliminate or prevent recipient fraud by: (a) preventing methods to defraud; (b) eliminating/reducing Medicaid ID card sale, alteration, lending, sharing or swapping; (c) eliminating/reducing drug overutilization; (d) eliminating/reducing failure to safeguard Medicaid cards; (e) eliminating/reducing medical ID theft.

The system described herein can include both office based models that are placed on desktops and table tops in medical offices and hospitals and mobile handheld scanners that can be used in emergency room situations, outdoor locations, etc. and can prevent fraud from occurring in the first place. For example, by requiring a patient to confirm arrival and verify identity, the system can keep a record of the recipient's presence. In various implementations, a provider may not be allowed to bill for services/goods provided if it cannot be verified that the recipient was physically present. As another example, in combination with the analytical tools to record and/or prove the amount of time spent with a home health care recipient, the system can also help increase the standard of care. Currently, some very simple examples of fraud occur when home health providers do not visit a home as many times as they claim in their billing records. For example, there may be providers who bill for providing a caregiver to visit a patient/recipient at their home five times a week, when in fact they only provide a caregiver three times a week. The additional two days of billing cycles are fraudulent. In most instances, the existing systems and methods are not able to keep a record of the number of times a caregiver visits a patient's home in a simple and efficient manner and thus there are very few ways in which such fraudulent practices can be detected and prevented. The systems and methods described herein can be used to detect and prevent such fraudulent practices. For example, in various implementations, the caregiver who visits a patient/recipient at their home may be required to obtain personal information from the patient/recipient (e.g. a biometric signature) at the start and the end of the services. This personal information along with the date and time stamp may be used to verify and process a bill. As another example, for elderly patients/recipients who require constant check-in, in various implementations, the system can require the physical presence of a home health provider to log in the patient at the start of services, for example, noon on Monday, and log them in again at the conclusion of service, i.e. 1 p.m. on Monday. The system can thus ensure that health care providers actually spend the time with the patient that they claim when billing. In various implementations, the systems and methods described herein can provide the state with proof that services were rendered as claimed.

As another example, a transportation provider who transports patients/recipients to hospitals or doctor's offices can alter records or falsify data and bill for transporting a larger number of patients/recipients (e.g. fifteen) than the number of patients/recipients that were actually transported (e.g. five). Various systems and methods described herein can be used to prevent such alteration of records. For example, with the system described herein installed in the transportation provider's vehicle, when a transportation provider has a genuine patient pickup, the driver can be required to obtain the patient/recipient's personal information (e.g. scan the patient/recipient's fingerprint and/or request a response to a security question) and/or obtain information from a token issued to the patient/recipient (e.g. a smart card) upon the patient/recipient's entry into the transport vehicle. In this manner the system can verify the identity of the patient/recipient, ensure that the patient/recipient is entitled to the benefit and keep a record of the time and date on which the service was provided.

As another example, consider a provider who bills for medical equipments/supplies and/or medicines that were in fact not delivered to a patient/recipient (also referred to as ghost billing). Using the system and methods described herein a patient/recipient can authorize and confirm delivery and receipt of all equipment/supplies and/or medicines and prevent ghost billing. Using the system and methods described herein medical equipment/supplies and drug companies can have a method to prove that delivery was initiated and completed.

In various implementations, stealing recipient/service provider information to impersonate a recipient/service provider can be prevented by using systems and methods described herein. For example, providers can require personal information (e.g. a biometric signature or a response to one or more security questions) before providing service. Similarly service providers may be required to provide personal information (e.g. a biometric signature or a response to one or more security questions) before providing service. This requirement to provide personal information by the recipient and/or the service provider can ensure that service was indeed provided by an authorized provider to an authorized recipient. Thus, stealing recipient/service provider numbers can become a useless enterprise for those impersonating a recipient/provider. Similarly, card sharing, swapping, substitution or other unknown schemes to impersonate a recipient and attempt to steal services can be eliminated.

The system described herein can mitigate many up-coding charges by allowing the patient/recipient to participate in authorizing bill payment through summary review. For example, in various implementations, a patient/recipient can review and/or authorize a summary of the service provided and charges incurred before the patient/recipient leaves the service provider's facility. In this manner, a visitation file that includes patient/recipient information, a summary of the service provided and the charges incurred can be closed at the time of departure from the service provider's (e.g. physician's) office any additions, changes, up-coding or bill upgrading may be stopped. Similarly, in the event that a service provider visits the patient/recipient at their home, the visitation file can be closed before the service provider leaves the patient/recipient's home.

In various implementations, the system may require personal information (e.g. a biometric data, biometric signature and/or response to one or more security questions at the start and/or at the end of a transaction. In this example, obtaining the personal information (e.g. biometric signature) at the close of the transaction may be considered as a confirmation of the care that was received and the date/time the care was received. In various implementations, a summary of the care that was provided can be displayed on a computer screen for the patient/recipient's benefit before the transaction is closed. Since providing personal information may be a requirement to open and close any visitation file, there are few avenues for a service provider to submit claims that do not directly correspond with the events at the time they are recorded. The systems and methods described herein can also prevent false billing for procedures claimed over a period of days when only one visit occurred. Without the authorization or physical presence of the patient, the visitation file may not be opened or closed and thus false billing can be prevented. In various implementations, a patient/recipient's personal information (e.g. biometric signature, biometric data and/or response to one or more security questions) may be required to log into the billing system. This feature can also aid in preventing fraudulent billing practices.

In various implementations, when the recipient closes the file, the billing payee who pays for the service (e.g the patient/recipient; the insurance company; the federal or the local state government) may receive a copy of the visitation file. The payee may record the amount to be reimbursed to the service provider and no further adjustments may be possible. This method can prevent a service provider from billing the payee before/after service was provided to the patient/recipient and thus may prevent fraudulent billing practices.

In various implementations, the system may prompt the service provider to provide/enter codes for services rendered. The system can also indicate at the time the service is provided whether the patient/recipient is entitled to that particular service. In various implementations, the system may automatically indicate to the service provider or the patient/recipient as to which of the service provided are covered by the patient/recipient's medical plan and which are not. In various implementations, the patients/recipients may be required to make payment arrangements directly with the service provider for non-covered services. By using the code system, service providers can automatically receive notification that the intended bill has a service listed for claim that is not covered by Medicaid. The adjustment to the bill will have to be made before the bill can be submitted. In this manner, the system described herein can make the billing process more efficient.

In various implementations, the system can include a pharmacy summary feature which lists all the medicines/drugs that a patient/recipient is prescribed. Service providers may be able to access the pharmacy feature to make changes to the prescription and identify possible drug interactions or symptoms of prescription abuse. In some implementations of the system described herein, a patient/recipient may present some personal information (e.g. a biometric signature, a biometric data and/or a response to one or more security questions) to receive a prescription from an authorized provider. The patient/recipient may additionally provide a token (e.g. an electronic card, a smart card, a cell phone, a smart phone, a tablet computer, etc.) that can be updated to include the additional data placed in the prescription section. This can ensure that patients/recipients may not be able to obtain medicine/drugs using a forged prescription. Using a combination of token and personal information at the point-of-transaction in the pharmacy can ensure that a complete record of the transaction occurs. In various implementations, the patient/recipient can authorize payment for the prescription medicines using a combination of the token and personal information. Using a combination of token and personal information can prevent any abuse of any stolen or misplaced card. For example, forging prescriptions and presenting them to receive medication, using false identities and false payment methods such as stolen debit cards, etc. to pay for the medication and avoid detection can become difficult if the systems and methods described herein are in place.

The systems and methods described herein can prevent medical identity theft since some personal information (e.g. a biometric signature, biometric data and/or response to one or more security questions) is required to obtain service. Furthermore, in various implementations, the patient/recipient's biometric signature, biometric data and/or responses to one or more security questions may be compared with personal information stored on a token and/or one or more information stores and service may be provided only if the personal information at the time of service matches the personal information stored on a token and/or one or more information stores.

The systems and methods described herein can provide simple and elegant proactive solution to the problems posed by Medicaid fraud. The system can also allow the detection and reporting of up-coding, overutilization and reveal suspected fraudulent use patterns. The system can systematically deter fraud through proactive prevention at the point-of-service transaction between recipients and providers, whether the primary care physician, hospital care, specialists, home health or even durable medical equipment supply. The entire spectrum of health care provision can be covered using the approaches described herein.

Although the above description is related to using the systems and methods described herein to prevent fraud in Medicaid, the systems and methods described herein are general and can be applied to a wide variety of applications such as validating and authorizing credit/debit card transactions, validating, authorizing and completing e-commerce based transactions, verifying identity and authorizing access for homeland security applications, verifying identity and allowing entry of travelers into the country, verifying identity of patient and allowing service providers to provide health care and bill insurance companies for the care provided, employment verification, etc.

The systems and methods described herein can be implemented for all service providers and recipients in a geographical area (e.g. a county, a state, etc.). Service providers who are enrolled in the system can receive the necessary equipment and training to use the system. Users/recipients who are enrolled in the system can receive a token for services, and provide their personal information (e.g. a biometric signature, biometric data, responses to one or more security questions, etc.) to create a unique secret personal identification number (PIN) which can then be used for the purpose of identification verification. In various implementations, the token may be a physical token (e.g. a personal smart card) or an electronic token (e.g. an application developed for an electronic device). In various implementations, the system can receive the personal information at the time the user/recipient enrolls in the system. The smart cards are ready to use and loaded with the personal information of the user/recipient. In various implementations, the personal information of the user/recipient can include biometric information, for example, finger print, retinal scan, palm print, face scan, etc. In various implementations, the personal information of the user/recipient can include responses to one or more security questions. In various implementations, the personal information of the user/recipient can include at least one of: a date of birth, a name, a place of birth, information regarding a financial or a medical account, a personal identification number, government issued benefit accounts information, government issued identification number (e.g. social security number), etc.

The systems and methods described herein are easy to install and use. For example, an enrolled service provider can install the hardware and software in about 30 minutes including training time. In various implementations, users of the systems/recipients can enroll into the system or activate their tokens when they visit the service provider location for the first time. In various other implementations, the users/recipients can enroll into the system remotely over the internet or wireless networks using their personal devices such as their smart phones (e.g. IPHONE®), their tablet computers (e.g. IPAD®), their personal computers, etc. In various implementations, the users/recipients can receive a token including their personal information at the time of enrolling. In various implementations, the users/recipients can receive a token including their personal information before or after enrolling into the system. In various implementations, the user/recipient may receive an electronic token including their personal information via email or from an internet site. In various implementations, the electronic token may be an application developed for an electronic device (e.g. smart phone app, tablet computer app, etc.). In various implementations, the user/recipient can use the token to process and complete transaction over the internet or at brick-and-mortar locations. In various implementations, the users/recipients of the system can use the token to establish their identity, gain access to a system or location, establish the time and date of obtaining a service, etc. In various implementations, the service providers may use the token to verify identity of a user/recipient, determine if the user/recipient is entitled to receive the service, control access of user/recipient or to record the time and date of attendance of the user/recipient. In various implementations, biometric information associated with the user/recipient may be obtained at the time of enrollment and recorded for future use. In various implementations, instead of or in addition to the biometric information, the recipient can also provide answers to a number of security questions (e.g. three, four, five, etc.) and present other forms of identification. Security questions may change on a periodic basis i.e. weekly, monthly, annually, etc. At the time of enrollment or at a later time, the provider may confirm the user/recipient's identity with a state, national or federal database.

In various implementations, the user/recipient can login or check-in to the system before receiving service from the service provider. At the time of logging or checking into the system, the user/recipient may provide personal information (e.g. biometric data, biometric signature, responses to one or more security questions, etc.) to establish their identity and their eligibility for the service. In various implementations, a visitation file may be opened at the time of logging in or checking into the system. In various implementations, the users/recipients can complete a check-out process after receiving service from the service provider, again, by providing personal information. In various implementations, during the check-out process, the visitation file for the user/recipient may closed and the provider/service timestamps for arrival and departure may be logged. In various implementations, an invoice may be generated for the service provided. In various implementations, the user/recipient may be provided with a copy of the invoice or a summary of the service provided.

The systems and methods described herein can also perform the functions of generating an invoice, coding for the service provided, verify the invoice amount, etc.

Various implementations of the systems and methods described herein is a product of processes written to reduce fraud in financial and retail environments. The system has been tested for the unbanked consumer (consumer without checking accounts) as a means for credit and debit card authentication and has been adapted to the health care field and Medicaid fraud prevention.

Various implementations of the system described herein comprises the processes of data storage, retrieval and manipulation, as well as biometric identity verification. Various implementations of the system can further include using information on a token (e.g. an updateable integrated circuit smart card) that is presented at point-of-transaction/delivery. In various implementations, the token can be mated with other information stored in one or more information stores. The information stores can be located in one or more remote servers. In various implementations, the information stored on the token and/or information stores can be split, scrambled and/or encrypted prior to storing. In various implementations, no piece of information on the token or the one or more information stores can be used individually in any form without the other. However, in other implementations, information that is not split or divided can also be stored on the token or in one or more information stores.

One possible advantage of the system and method described herein is that the user/recipient can control all access to the data. For example, in various implementations, the personal/medical/financial information associated with the user/recipient can be split into multiple separate and distinct portions and each of the multiple portions can be stored either on the token or in one or more information stores. The multiple separate and distinct portions of information stored on token and one or more information stores may be inaccessible and unusable until the user/recipient logs into the system by providing some personal information or the token or both. Once the user/recipient logs into the system, the multiple separate distinct portions of information are retrieved from the token and the one or more information stores and combined for use. The system can thus provide a level of security against theft and/or misuse of information stored on the information stores by hackers.

In various implementations, the user/recipient's data cannot be accessed by anyone without the user/recipient's consent. Additionally, the data cannot be reconstructed in order to be used to confirm identity or process payment without the user/recipient's consent. For example, in one implementation of the system the biometric information obtained from the user/recipient may be divided into multiple distinct portions and each portion of the multiple portions is stored either on a token associated with the user/recipient or in one or more information stores. Each piece is stored in a manner such that it would not be possible to regenerate or recreate the biometric information based on an individual piece or a group of pieces. When the user/recipient logs into the system, for example, by providing a token, a biometric signature and/or response to one or more questions, each of the multiple distinct pieces are retrieved from the token and one or more information stores and used to confirm the identity of the user/recipient. In this manner, the system can be used to only confirm identity not reproduce it.

In various implementations, users of the system or the recipients are provided with a smart card that includes personal information related to the recipient. In various implementations, the smart card can be used as a token. The smart card can reduce the administrative burden on providers by automating and streamlining the process of eligibility determination and accessing basic medical information usually gathered every time a patient visits. For example, when a user/recipient arrives at a medical facility to receive medical services, the smart card in combination with biometric signature and/or responses to one or more security questions can be used to verify and confirm the user/recipient's identity and eligibility.

The user/recipient's privacy and his/her identity can be protected and safeguarded by splitting/dividing personal information associated with the user/recipient into multiple portions and storing each of the multiple portions either on the smart card or in one or more information stores. In various implementations, the information stores can be located in one or more remote servers or a personal electronic device (such as a smart phone or a table computer) belonging to the user/recipient. In various implementations, the smart card can be a smart phone or a tablet computer associated with the user/recipient. In such an implementation of the smart card, the information stores are included in the smart card itself. In various implementations, the information may be scrambled, encrypted or scrambled and encrypted prior to splitting in multiple portions and storing. In various implementations, each of the multiple portions may be scrambled, encrypted or scrambled and encrypted prior to storing. In various implementations, important information can be split/divided, and blocks of less important information can be split/divided and scrambled. Each of the multiple pieces can be at least double encrypted and one portion can be stored on the card and the remaining portion can be stored in one or more information stores.

To retrieve and unite the multiple portions of the information, the system requires the smart card, and a confirmed identity. Only the owner of the card can allow access to that information or use the card as an identifier. Scammers cannot use the personal identity of Medicaid recipients to obtain services and thus reducing the chance of a medical fraud. Additionally, by allowing the user/recipient to control access to the information, it is less likely that incorrect medical data (allergies, diabetes, drug use, etc) will be added to recipients' records, which could lead to improper treatment, and possibly death. Thus, the user/recipient can have the security that the information stored on the card will not be misappropriated or misused in the event they lose the card. Furthermore, organized crime cannot reproduce, alter, copy or adapt the smart card for their use. For example, they cannot create a duplicate card and place other prescriptive data on it. In this manner, the system can be use to reduce and prevent crime.

In various implementations, because the personal information is stored in one or more information stores the users/recipients can be assured to have access to services when their card is not available. In various implementations, if the user/recipient's card is unavailable, they can confirm their identity and eligibility by answering their security questions and/or using their biometric signature at the place they receive services. In this manner, they can continue to receive services while waiting for a new card to arrive.

In various implementations, a single smart card may be used to store personal information for several different authorized users. For example, personal information associated with each member of a family (e.g. husband, wife and children) can be stored on a single smart card. Currently, a parent may be required to carry and provide multiple cards for each child receiving services. However, users of the system may include a number of children (e.g. two, four or six) on the parent's smart card. In various implementations, each child may have his or her own individual card, as well which may be advantageous as children can have instant access to care, even when they are at school, at a non-custodial parent's home, or in foster care.

As discussed above, the systems and methods described herein can be designed such that information associated with a user/recipient cannot be retrieved or a user/recipient cannot be authorized unless the user/recipient logs/checks into the system. In various implementations, the user/recipient can log/check into the system by being physically present and confirm their arrival by providing the smart card and/or a biometric signature and/or response to one or more personal questions. In various implementations, the user/recipient can log/check into the system electronically. In various implementations, the user/recipient may be required to approve the transaction after the service has been provided. For the recipient logging in, if their identity and eligibility is confirmed, the transaction proceeds and services will be provided. However, if identity and eligibility is not confirmed, the transaction is cancelled and service is either not provided or in the event the service has already been provided then the authorized payee cannot be billed for the service and payment for service must be obtained from other sources in order to proceed. For example, payment for medical services cannot be obtained from the state or federal government or an insurance company without physical proof of recipient identity in real time, followed by eligibility verification. In this manner, the systems and methods described herein can be the recommended proactive method for preventing fraud before it occurs.

The smart card technology and identity verification system, as described herein may be advantageous in eliminating/reducing fraud. With important personal information (e.g. patient data) being kept in a secure mode, the system has provided solutions to genuinely identify each user/recipient (e.g. patient) at the point-of-service, eliminate fraud at its many sources, reduce the investigative and other burdens on part of the payee (e.g. the state/federal government, insurance companies, etc.) and prevent payment for fraudulent services.

The systems and methods described herein to prevent Medicaid fraud can be also employed to stop retail personal identification fraud, check fraud, credit card fraud, insurance fraud, government provided electronic benefit card fraud and other systematic types of fraudulent activity across the range of retail-to-consumer transactions.

For example, the systems and methods described herein can be used to prevent check cashing fraud which is a type of fraud closely related to Medicaid fraud. The systems and methods described herein can be used to verify identity at point-of-transaction, for example, at retail locations, at banks, etc. The system would be able to assist legitimate logins and avoid criminal attempts.

The smart card can also be used for retail merchant/consumer transactions with identity verification and payment processing. For example, the smart card can be used at various locations including retailers, e-commerce sites, restaurants, physician's offices, eye care professionals, dentists, durable medical equipment stores, in emergency medical vehicles, pharmacy, hospitals, etc.

The smart card can provide benefits for general retailers and banks by offering security against fraud.

The smart card can also provide benefits to emergency management. For example, a common problem among victims in emergencies is recalling important personal medical information. With the smart card, the most vital details needed by medical personnel are immediately available by swiping the smart card and applying the biometric verification to retrieve the data.

The smart card can also provide benefits to physicians. For example, currently, physicians worry about the ability to accurately decipher medical information given by consumers. With an aging population, many have illegible handwriting and forget details of their medications and treatment regimens. The majority of them suffer some degree of memory loss. The smart card can reduce physician liability by providing consistent, media readable, easily deciphered and available, viable medical information. In various implementations, the medical information stored on the token or one or more information stores can be similar to the electronic medical records maintained by the doctor's office or hospitals. In various implementations, the medical information stored on the token or one or more information stores can be more or less comprehensive than the electronic medical records maintained by the doctor's office or hospitals

The smart card can also provide benefits to the consumer. The card can afford all consumers personal identity security, financial records security, medical record security, and, no consumer has to remember pin numbers. In contrast, personal identifiers can be lost or stolen with any other card. Because all data is kept locked until the biometric signature or security questions and identification is presented, consumer does not have to worry that their private information could be stolen.

In various implementations, users/recipients can designate authorized individuals who can have access to the information stored on smart card and the one or more information stores. This can be particularly beneficial to caregivers who are taking care of an aging family member. For example, caregivers taking care of an aging parent can help monitor the parents' medications and the medical services accorded to them. In various implementations, the smart card may also be used to store prescription information. This can provide additional benefits for the elderly as they need not fill in forms for multiple physicians, and not carry bags of medication for review, all of which can make doctor's visits more efficient and streamlined. This streamlined method can also assist in keeping accurate prescription records. In various implementations, the smart card may additionally be used to store electronic medical records or prescription information.

One method of implementing the system is described below. The method includes providing authorized service providers with devices that can obtain personal information from the users/recipients. These devices can include biometric scanners, smart card readers, etc. In addition, service providers may be provided with instructions and software required to operate these devices. In various implementations, the installation of the devices and training can take approximately 30 minutes. Tokens (e.g. smart cards) can be programmed with the portions of personal information (e.g. biometric data, biometric signatures, responses to one or more security questions) and distributed to the users/recipients at the time of enrollment. Users/Recipients can activate their tokens on their next visit to the service provider (e.g. their primary care physician) by providing their biometric signature and/or responses to security questions.

In various implementations, the biometric information (e.g. a fingerprint, a palm print, a skin print, a footprint, a retinal scan, a face scan, a vein scan, a heart scan, a voice signature, personal signature, etc.) can be captured and divided/split into multiple portions. Each of the multiple portions is stored either on the token or in one or more information stores. In various implementations, the captured biometric information can be converted into an alphanumeric code prior to being stored. In various implementations, the captured biometric information can be divided into multiple portions and each multiple portion can be converted into an alphanumeric code prior to being stored. In various implementations, the biometric information is not stored in its entirety in one location. At each subsequent visit, the user/recipient may be asked to provide the biometric information which is then matched to the stored biometric information to verify identity.

In another method of activating the token, the user/recipient can provide a form of identification (e.g. drivers license, passport, etc.) and is asked a certain number of security questions (e.g. two, three, four or five) from a list of possible questions. The questions may be different for each recipient and can include details of their history, personal identifiers such as a child's birthday, first car owned, favorite movie, etc. The answers provided by the user/recipient are stored on the token or the one or more information stores or both. In various implementations, the answers provided by the user/recipient are divided prior to being stored. In various implementations, the answers provided by the user/recipient are divided and then scrambled or encrypted or both prior to being stored. At each subsequent visit, the user/recipient may be asked to answer one of the randomly selected security questions and/or present his/her form of identification to verify identity. In various implementations, the security question method of verifying identity may be used instead of or in combination with the biometric method of verifying identity.

In various implementations, the identity verification methods described above can confirm the user/recipient's identity, then communicate with an external database (e.g. a national database) to confirm the user/recipient's eligibility the state database to confirm Medicaid eligibility and retrieve additional information stored on the token and one or more information stores.

In one method of implementing the system, the service provider (e.g. the receptionist at the doctor's office) can startup the software in the morning in preparation to receive patients and check them in to the system. When a patient arrives, the service provider may request the patient to provide the smart card and/or a personal information (e.g. biometric information, response to one or more security questions or both) at the time of check-in. Information from the smart card may be retrieved by using a card reader. In some implementations, the identity and eligibility of the patient is verified along with retrieving information from the card or before retrieving information from the card. Additional medical information can be retrieved from one or more information stores using the information obtained from the smart card and/or the personal information provided by the patient. The additional medical information can be combined with the information obtained from the smart card and assembled and made available for onscreen review by medical staff and/or the patient. The information available onscreen for review, include, but are not limited to, insurance or other medical benefits information; prescription drug information; information regarding major surgeries, immunization, allergies, major health concerns; and emergency contact information. All of this information can also be reviewed and confirmed by the patient at any time. In this manner, records can be maintained more efficiently and their current status can be ensured, thus resulting in less chance of medical error. In various implementations, the patient may present his/her token in the presence of the doctor providing the service. In various implementations the doctor can be provided with a token and information may be split between the doctor's token and one or more information stores. In various implementations, the records stored on the patient's token may be compared with the records stored on the doctor's token to identify any discrepancies.

In this manner, the smart card can reduce the administrative burden on providers by automating and streamlining the process of eligibility determination and accessing basic medical information usually gathered every time a patient visits. For example, in various implementations, the service provider (e.g. the doctor's office) can confirm the patient's identity and access their medical history through one card.

After services are rendered, the patient can be asked to present their smart card and provide their biometric signature and/or answers to their security questions again for check out procedures. Besides closing out the medical transaction records, time logs may be stamped during check-out. Additionally, an invoice may be generated during check-out. In various implementations, the invoice may be forwarded to the payee for payment and a copy of the invoice may be provided to the patient. On all subsequent visits to any provider, recipients repeat the check-in and check-out procedures.

Many elderly patients who are enrolled in the Medicaid system may be incapable of writing, or the information to be updated is beyond their education level, or they may not speak English. By accommodating a variety of capabilities, the systems and methods described herein allow patients to have their important medical information maintained and checked without burdening the patient with additional paperwork.

As a result of the system, the patient's are empowered to protect their own identity and to share concerns about fraud with government agencies. They have an increased sense of the connection between their care and the prevention of inaccurate billing. Additionally, the secure, private database that is used to keep a record of the various Medicaid transactions, can provide a wealth of information for analysis by the payee (e.g. the state/federal government or insurance company).

The system described herein is simple in its construction and can be very cost effective. These features may make the system attractive for use at various transaction locations by retailers, government organizations, health care providers, etc.

In various implementations, the user/recipient of the system may incur no direct cost for the use and maintenance of their tokens. For example, they may receive their tokens and have their personal information stored for no charge. The retailer, service provider or the payee may be charged a minimal fee to purchase and distribute the tokens to recipients and/or to use the system for verification purposes. The retailer, service provider or the payee may have the ability to design the tokens to suit their purposes.

The system can link any amount of information to the user/recipient's token. The fingerprint scan can occur at any point-of-login or transaction location and no special preparation is required. The system is designed with a modular and scalable architecture such that as the number of participating providers and users increases, and the number of transactions processed by the system increase, the system can be scaled to accommodate the higher data storage and throughput requirements.

Various implementations of the system are developed around the FBI PIV (Personal Identity Verification) standard for fingerprint image and quality assurance. This can ensure that the system can adapt to new biometric information reading methods and algorithms that may be developed in the future. As the process of biometrics, readers and communication technology improves, so does the system's capabilities.

The information can be scrambled and/or encrypted during transmission and storage. The data storage facilities employed by the system can be designed to offer high levels of security, redundant backups, and redundant power supplies.

The systems and methods described herein have several advantages over other similar systems. For example, other systems may have biometrics, but the biometric is stored on the token entirely or in its original form, and if the token is stolen, then the biometric is stolen. There is no security of recipient personal identity or medical record information with those systems. In contrast, in the system described herein, the biometric information is divided into multiple portions and the multiple portions are stored at different logical or physical locations on the same token or partly on the token and partly in one or more information stores. Thus, if the token is stolen, the biometric information associated with the user/recipient is not compromised.

Also, products that store the biometric in its original form entirely on the token enable providers who want to commit fraud to file recipient claims that have not been authenticated by the recipient by stating that the recipient did not have their card present. So, the payee ends up in the predicament of either paying a possible fraudulent claim, or, having to deny access to recipients who may have legitimately lost their card, or who may not have it present at the time.

The other problem with storing biometrics in its original form entirely on a token, is that it creates an atmosphere in which criminals/hackers can recreate tokens with their own biometrics using someone else's Medicaid number.

Other similar systems claim they can overcome these problems by storing a second set of biometrics on a database for verification, but this still exposes the recipient's complete identity to theft, both their biometric and medical information.

One of the safest and most secure ways to store personal and medical data, as well as the biometric, is to split/divide the information into multiple portions, store a some parts of the multiple portions on the token and the remainder in one or more information stores. In various implementations, the multiple portions may be scrambled and/or encrypted before storing to provide increased security. In various implementations, to increase security of the biometric information can be divided/split into multiple portions and each of the multiple portions is converted into an alphanumeric code prior to being stored. In various implementations, the biometric information can be divided and encrypted prior to being stored. In various implementations, the biometric information is converted to a secret PIN and the secret PIN is stored instead of the actual biometric information.

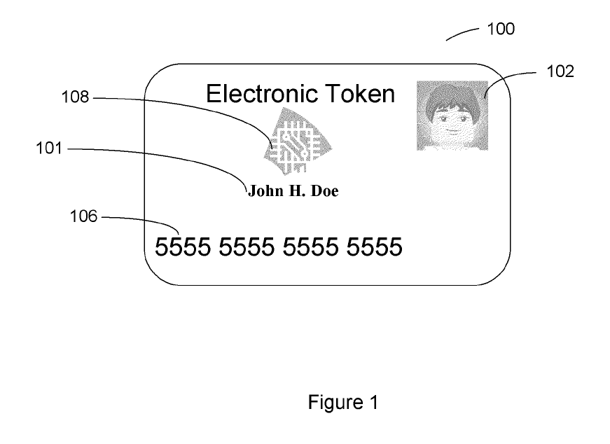

FIG. 1 illustrates a token 100 that can be used by a user/recipient issued as a part of the verification system described herein or can be a token already owned by the user/recipient. The token 100 and the system described herein can be used to complete a financial transaction (e.g. cash a check, receive disability payments, etc.); to obtain goods and services in exchange for payment; to obtain service from a service provider (e.g. a doctor, an automobile mechanic, a plumber, etc.) which will be paid for by a payee organization (e.g. health insurance company, automobile insurance company, home insurance company, etc.); to establish identity for access control or to establish time and date of presence; etc. In various implementations the token 100 may be used to verify identity of a user/recipient by a retailer/service provider or government authorities and to confirm eligibility of the user/recipient. In various implementations, the token 100 may be used to store an individual/user/recipient's financial, medical and other personal information. In various implementations, the personal information can include biometric information (e.g. a finger print, a skin print, a palm print, a footprint, a retinal scan, a face scan, a vein scan, a heart scan, personal signature or a voice signature) associated with the user/recipient. In various implementations, the personal information can include response to one or more security questions. In various implementations, the personal information can include at least one of: a name, an address, a date of birth, a place of birth, information regarding a financial account, a government assigned identification number and information regarding a medical account.

In various implementations, the token 100 may be a physical token (e.g. a personal smart card) or an electronic token (e.g. an application developed for an electronic device). In various implementations transaction the token 100 can include but not be limited to a card, a tag, a negotiable instrument, a credit card, a debit card, a loyalty card, a decoupled debit card, a device enabled with radio frequency identification, a smart card, a flash drive, a usb thumb drive, a usb pen drive, a usb pin drive, a smart phone (e.g. an IPHONE®), a tablet computer (e.g. an IPAD®), an application developed for an electronic device, an electronic benefit card, an insurance card or a food stamp. In various implementations, the token 100 can include a card with one or more electronic circuits or chips 108 that can store the personal information in electronic form. In various implementations, the token 100 can optionally comprise a region 102 that can include a picture of the individual to whom the token 100 is issued. The name of the individual to whom the token 100 is issued can be included in the area 101 of the token 100. A token number 106 can be associated with the token 100. In various implementations, the token number can be linked to the individual name and other personal information. In various implementations, the personal information can be stored in a magnetic strip or a bar code provided on the token 100.

In various implementations, the token 100 is issued or activated when the user/recipient enrolls in the system. In various implementations, the users/recipients can enroll in the system by providing their personal information (e.g. a biometric signature, biometric data, responses to one or more security questions, etc.). In various implementations, the biometric data and responses to one or more security questions may be used to create a unique secret personal identification number (PIN) which can then be used for the purpose of identification verification. Personal information can be stored on the token 100 at the time of enrolling the user/recipient into the system. The information stored on the token 100 can be updated subsequently (e.g. during/after every transaction).

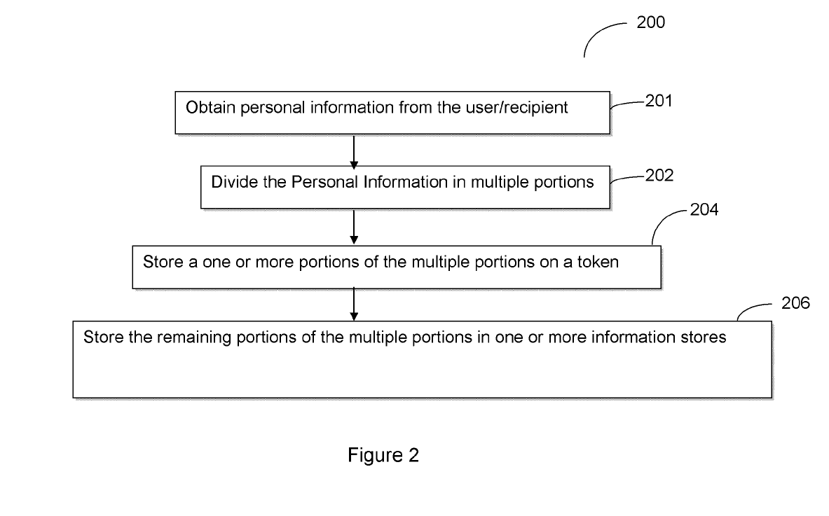

FIG. 2 shows a method 200 of storing information. As indicated in block 201, personal information is obtained from a user/recipient. The personal information (e.g. financial information, medical information, etc.) is divided into multiple portions as shown in block 202 of FIG. 2. One or more portions of the multiple portions can be stored on the token 100 as shown in block 204 of FIG. 2, while the remaining portions can be stored in one or more information stores as shown in block 206. The information stores can be located in one or more remote servers. In some implementations, the information can be scrambled and/or encrypted prior to or after being split in multiple portions and stored.

In various implementations, the division and storing of the personal information can be performed when a new token 100 is issued to the user/recipient or subsequently when the token 100 is used during a transaction.

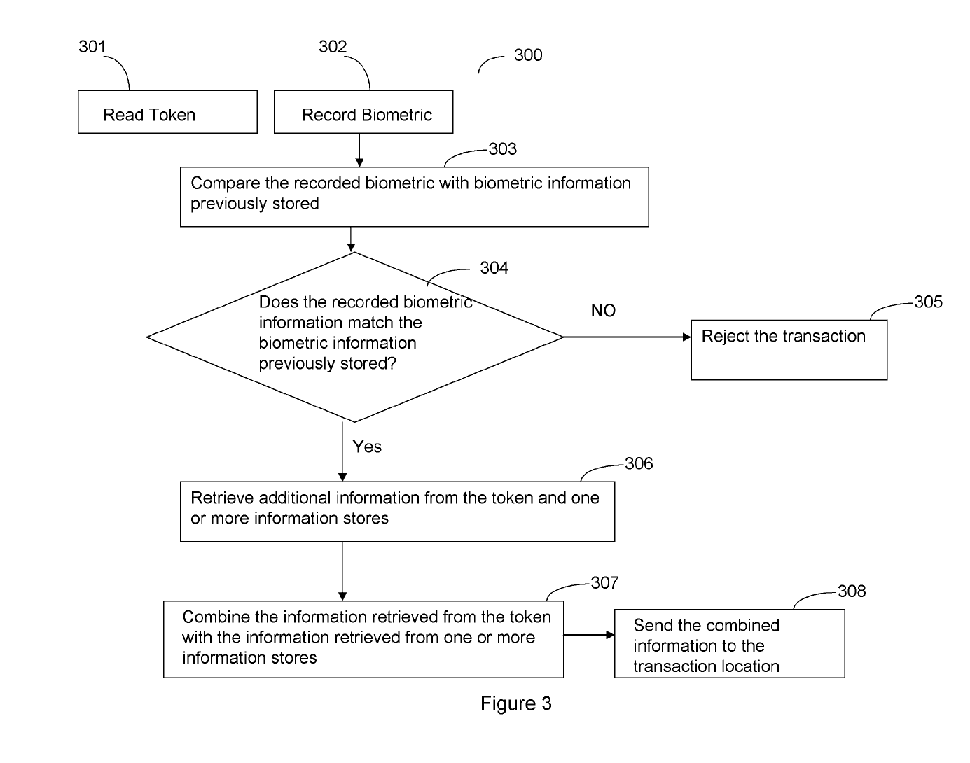

FIG. 3 shows a method 300 of processing and completing a transaction using the token 100. When the user/recipient presents the token 100 for the purpose of a transaction or for the purpose of establishing identity or when there is a need to retrieve information from the token 100, information is obtained from the token 100 as shown in block 301 of FIG. 3. In various implementations, the information can be obtained by a device (e.g. a token reader). In various implementations, a biometric information associated with the user/recipient presenting the token 100 is also recorded as shown in block 302 of FIG. 3. In various implementations, the biometric information can be recorded by a biometric scanner. In various implementations, other personal information such as response to one or more security questions can also be obtained instead of or in addition to the biometric information. In various implementations, the biometric information recorded at the time of transaction can be compared with the biometric information stored on the token and/or one or more information stores to verify the identity of the user/recipient as shown in block 303 of FIG. 3. For example, in one implementation, the multiple portions of biometric information stored on the token and in one or more information stores are retrieved and combined and compared with the biometric information obtained at the time of transaction. If the biometric information obtained at the time of transaction does not match the biometric information stored in the system or on the token or the combined information retrieved from the one or more information stores and the token, a message can be sent to the transaction location to request more information or reject the transaction as shown in block 305 of FIG. 3. However, if the biometric information obtained at the time of transaction matches the biometric information stored on the token or the one or more information stores or the combined information then the identity of the user/recipient is verified and the system can retrieve additional information stored on the token and additional information that is associated with the user/recipient and stored in one or more information stores as shown in block 306. The additional information that is stored on the token is combined with the additional information that is stored in one or more information stores as shown in block 307. This combined information is used to process the transaction. In various implementations, the combined information may be forwarded to the transaction location for further processing as shown in block 308 of FIG. 3 or may be sent directly to one or more processors for processing.

In various implementations, the information stored in one or more information stores can be retrieved or accessed using the biometric information obtained at the time of transaction. In various implementations, the information stored in one or more information stores can be retrieved or accessed using the token number associated with the token 100. In various implementations, the information stored in one or more information stores can be retrieved or accessed by using at least one of: the biometric information obtained at the time of transaction, the token number associated with the token, a customer identification number, government issued identification number, date-of-birth associated with the user/recipient, name of the user/recipient, or other personal information described above. In various implementations the one or more information stores may be indexed according to one of: biometric information, personal identification number, a personal information described above, etc. Other known methods of accessing and retrieving information stored in one or more information stores can also be used.

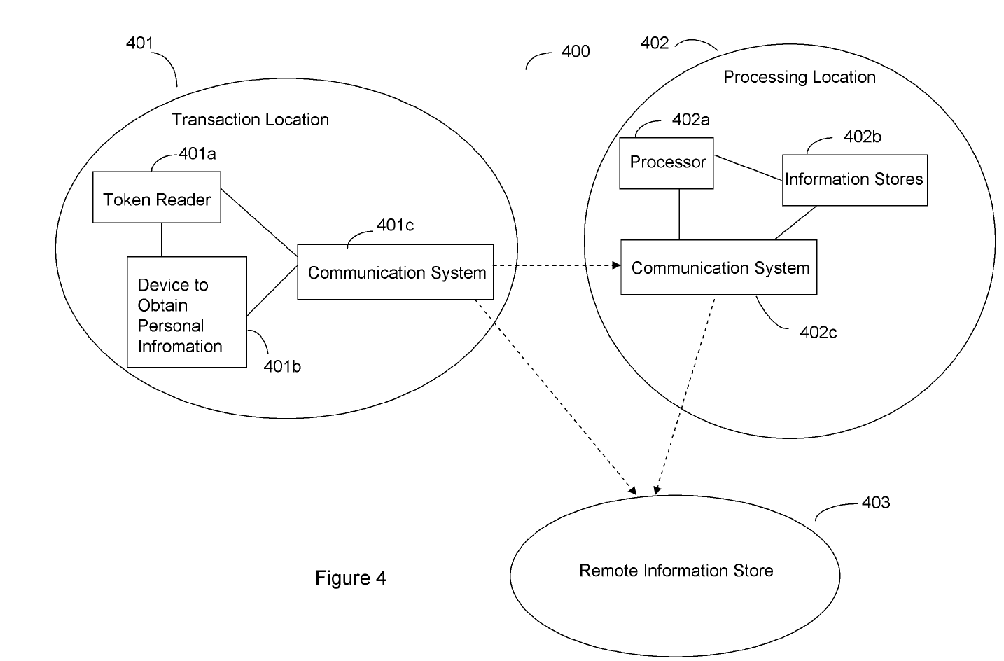

FIG. 4 illustrates an example of a system 400 that is used to process a transaction using the above described methods. As illustrated in FIG. 4, the system 400 includes a transaction location 401 where the user/recipient initiates the transaction by presenting a token (e.g. token 100) and a processing location 402 where the transaction is processed. In various implementations, the system 400 can further include one or more information stores 403 that are located at a location remote to the transaction location 401 and processing location 402. In various implementations, the transaction location 401 can include a device 401a configured to obtain information from a token 100 presented by the user/recipient, a device 401b configured to obtain personal information from the user/recipient; and a communication system 401c. In various implementations, the processing location 402 can include one or more processor 402a, one or more information stores 402b and a communication system 402c. In various implementations, the transaction location 401 can be a physical location such as a retail store, a doctor's office, etc. In various implementations, the transaction location 401 can be an e-commerce site. In various implementations, the transaction location 401 can be the processing location 402. In various implementations, the device 401a can be a token reader. In various implementations, the token reader 401a can include one or more information stores and/or one or more processors. In various implementations, the device 401a can be the token itself. For example, when the token 100 is an application developed for an electronic device, then the electronic device can obtain information from the token and using a different application. In such instances the token reader and the token are included in the same electronic device. In various implementations, the device 401a can include a smart card reader, a scanner, a bar code decoder, a magnetic strip scanner, etc. In various implementations, the device 401b configured to obtain personal information can be a biometric scanner. In various implementations, the device 401a and the device 401b can be combined into a single device. In various implementations, the communication system 401c can be configured to communicate with the processing location 402 and/or one or more remote stores 403.

In various implementations, information from the transaction location 401 can be forwarded to the processing location 402 and vice versa. In various implementations, the processor 402a at the processing location 402 can verify the identity of the user/recipient by comparing the personal information obtained from the user/recipient with the information stored on the token and/or one or more information stores (e.g. 401a, 402b and 403). In various implementations, the information obtained from the token and/or the one or more information stores can include multiple sub-portions. In such implementations, the processor 402a may combine or re-mate the multiple sub-portions before processing the transaction and/or verifying the identity. If the identity of the user/recipient is verified then the processor 402a may retrieve additional information associated with the personal information of the user/recipient and/or information associated with the token from one or more information stores (e.g. 401a, 402b and 403). The processor 402a can then combine (or remate) the additional information with information obtained from the token and process the transaction. In various implementations, processing the transaction can include returning a result to either accept or reject the transaction to the transaction location 401. In various implementations, processing the transaction can include confirming the identity. In various implementations, the transaction location 401 may be provided with a processor that can perform some or all the functions performed by the processor 402a.

Although the above described systems and methods are related to fraud prevention in transactions or point-of-transaction applications, the systems and methods described herein are general and can be applied to a wide variety of applications such as homeland security; health care; employment verification.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of storing information on a token, the method comprising:
obtaining personal information from a user;
dividing the personal information into multiple portions;
storing one or more sub-portions of the multiple portions on a token associated with the user; and
storing remaining sub-portions of the multiple portions that are different from the one or more sub-portions in one or more external information stores.

2. The method of claim 1, wherein the personal information comprises biometric information associated with the user.

3. The method of claim 2, wherein the biometric information associated with the user comprise a finger print, skin print, a retinal scan, a palm print, a face scan, a footprint, a vein scan, a heart scan or voice signature.

4. The method of claim 1, wherein the personal information comprises responses to one or more security questions.

5. The method of claim 1, wherein the personal information comprises at least one of: a name, an address, a date of birth, a place of birth, information regarding a financial account, information regarding a medical account, government issued benefit accounts and government issued identification numbers.

6. The method of claim 1, wherein the token comprises a negotiable instrument, a credit card, a debit card, a loyalty card, a decoupled debit card, a device enabled with radio frequency identification, a smart card, a flash drive, a usb thumb drive, a usb pen drive, a usb pin drive, a smart phone, a tablet computer, an application developed for an electronic device, an electronic benefit card, insurance card, a card with one or more electronic circuits and a food stamp.

7. The method of claim 1 further comprising:
dividing the one or more sub-portions into multiple parts;
storing a first sub-part of the multiple parts at a first location on the token; and
storing a second sub-part of the multiple parts at a second location on the token.

8. The method of claim 7, wherein the first and second locations can be physical locations on the token.

9. The method of claim 7, wherein the first and second locations can be logical locations on the token.

10. The method of claim 1, wherein at least some of the multiple portions are encrypted prior to storing.

11. The method of claim 1, wherein at least some of the multiple portions are scrambled prior to storing.

12. The method of claim 1, wherein at least some of the multiple portions are scrambled and encrypted prior to storing.

13. The method of claim 1, wherein at least one of: scrambling and encrypting happens before the information is divided and stored.

14. The method of claim 1, wherein the user can present the token for the purpose of a financial transaction.

15. The method of claim 1, wherein the user can present the token for the purpose of verifying identity.

16. A method of processing a transaction at a location where a token is presented by an individual, the method comprising:
obtaining personal information from an individual presenting a token;
obtaining information from the token;
accessing one or more information stores using at least one of: a portion of the personal information obtained from the individual and the information obtained from the token;
retrieving information from the one or more information stores;
combining the information obtained from the token with the information retrieved from the one or more information stores; and
using the combined information along with the personal information from the individual to process the transaction.

17. The method of claim 16, wherein the personal information comprises at least one of: a biometric datum or a response to a security question.

18. The method of claim 16, further comprising comparing the obtained personal information with the information obtained from the token and accessing one or more information stores if the obtained personal information matches the information obtained from the token.

19. The method of claim 16, wherein the information obtained from the token includes multiple sub-portions.

20. The method of claim 19, wherein the multiple sub-portions of the information obtained from the token are combined before combination with the information obtained from the one or more information stores.

21. The method of claim 16, wherein the information obtained from the one or more information stores includes multiple sub-portions.

22. The method of claim 21, wherein the multiple sub-portions of the information obtained from the one or more information stores are combined before combination with the information obtained from the token.

23. The method of claim 16, wherein the information from the token is obtained using a device configured to read the token.

24. The method of claim 16, wherein the information from the token is obtained using an application developed for an electronic device.

25. The method of claim 16, wherein the information retrieved from the one or more information stores can be at least one of: a portion of the personal information and a portion of the information retrieved from the token.

26. A transaction verification system comprising:
a device configured to obtain information stored in a token;
a device configured to obtain personal information from a customer associated with the token; and
a communication system configured to communicate with a transaction system,
wherein the transaction system is configured to retrieve information associated with the token that is stored in one or more information stores, and
wherein the transaction system is configured to combine the retrieved information with the information obtained from the token to process the transaction.

27. The system of claim 26, wherein token comprises at least one of: a negotiable instrument, a credit card, a debit card, a loyalty card, a decoupled debit card, a device enabled with radio frequency identification, a smart card, a flash drive, a usb thumb drive, a usb pen drive, a usb pin drive, a smart phone, a tablet computer, an application developed for an electronic device, an electronic benefit card, insurance card, a card with one or more electronic circuits and food stamp.

28. The system of claim 26, wherein the obtained personal information includes at least one of: a biometric datum or a response to a security question.

29. The system of claim 26, wherein the device configured to obtain personal information includes a biometric scanner.

30. The system of claim 26, wherein the device configured to obtain information stored in a token includes a token reader.

31. The system of claim 26, wherein the device configured to obtain information stored in a token includes the token.

32. The system of claim 26, wherein the transaction system is configured to verify personal information obtained with the personal information previously stored.

33. The system of claim 32, wherein the personal information previous stored may include multiple sub-portions.

34. The system of claim 26, wherein the information retrieved from one or more information stores includes a portion of information associated with the token.

35. The system of claim 26, wherein the information retrieved from one or more information stores includes a portion of personal information associated with the customer.

36. The system of claim 26, wherein the information from one or more information stores is retrieved using at least one of: a portion of the obtained personal information and a portion of the information obtained from the token.
